(19) United States
(12) Patent Application Publication
(10) Pub. No.: US 2017/0124227 A1
(43) Pub. Date: May 4, 2017

(54) AIR CONDITIONING LINE FILL PORT STRUCTURAL ANALYSIS

(71) Applicant: FORD GLOBAL TECHNOLOGIES, LLC, Dearborn, MI (US)

(72) Inventors: Bernardo Chavez Rivas, Mexico City (MX); Olmo Dario Villegas Lopez, Mexico City (MX); Rafael Uscanga Ruiz, Mexico City (MX); Trenton S. Meehan, Ann Arbor, MI (US); Felipe Luna Bonilla, Toluca (MX)

(21) Appl. No.: 14/927,761

(22) Filed: Oct. 30, 2015

(51) Int. Cl. G06F 17/50; G07C 5/12

(52) U.S. Cl. CPC G06F 17/5009; G07C 5/12

(57) ABSTRACT

A system for virtual testing of a vehicle air conditioning system includes a processor-based subsystem executing instructions including at least a rendering engine configured to render a three-dimensional A/C line assembly geometry representation and an finite element analysis engine configured to simulate an A/C refrigerant charging process. The finite element analysis engine simulates a refrigerant charging process including one or both of an application of a vertical load on the simulated A/C line assembly and at least one horizontal load applied on the simulated fill port. The finite element analysis engine calculates one or both of a fully applied vertical load and/or horizontal load fill port deflection and a residual simulated A/C line assembly deflection. The rendering engine is configured to render a representation of a fill port strain contour at one or both of during and after the simulated application of the horizontal and vertical loads.

### TECHNICAL FIELD

This disclosure relates generally to vehicle air conditioning (A/C) lines. More particularly, the disclosure relates to a process for analysis of structural performance of an A/C line assembly, such as during a refrigerant charging process completed during vehicle assembly.

### BACKGROUND

During the process of assembly of a vehicle, automotive refrigerant is supplied to the vehicle air conditioning (A/C) system via a fill port which in turn is in fluid connection with tubing comprising the A/C line assembly. During the process of refrigerant charging, the fill port and A/C tubing are subjected to a variety of stresses due to the weight of the fill equipment, the process of connecting the fill equipment to the fill port, and vehicle displacement such as on an assembly line during the filling/charging process. However, presently there is no standardized process for analyzing A/C line integrity.

To meet this need in the art, the present disclosure relates at a high level to a process and system for analysis of structural integrity of A/C lines. Advantageously, the process is accomplished as a virtual process, allowing a determination of structural integrity prior to any step of refrigerant filling and without necessitating physical stress tests of actual A/C system componentry. This provides significant advantages in the modern automotive manufacturing facility, where typically multiple automotive styles/models are manufactured and assembled, each potentially requiring a distinct A/C line configuration/geometry.

### SUMMARY

In accordance with the purposes and benefits described herein, in one aspect a computer-implemented system for virtual testing of a vehicle air conditioning (A/C) system configuration is described. The system includes a programmable processor-based subsystem including at least one processor operable to execute computer-readable instructions, at least one graphics processing unit, and at least one memory. In embodiments, the computer-readable instructions include at least a rendering engine configured to render a three-dimensional A/C system representation simulating an A/C system geometry including at least an A/C fill port and at least one A/C line and an A/C line material property. The instructions also include at least an finite element analysis engine configured to simulate an A/C refrigerant charging process.

The finite element analysis engine is configured to simulate a refrigerant charging process including an application of one or both of, by a simulated refrigerant fill tool, a vertical load on a z-axis of the simulated fill port and at least one horizontal load applied on an x-axis of the simulated fill port. The finite element analysis engine is also configured to calculate one or both of a simulated fill port deflection at a maximum applied vertical load and/or horizontal load and a residual simulated fill port deflection after the application of the vertical load and/or the horizontal load.

In embodiments, the finite element analysis engine is configured to simulate a refrigerant charging process including application of the horizontal load over a 360 degree circumference surrounding the z-axis of the simulated fill port. The finite element analysis engine is configured in embodiments to simulate a refrigerant charging process including application of the horizontal load over a 360 degree circumference surrounding the z-axis of the simulated fill port in 45 degree increments. In embodiments, the finite element analysis engine is configured to simulate a refrigerant charging process including at least an application and a release of a vertical load of about 15 pounds-force and an application and a release of a horizontal load of about 5 pounds-force.

The rendering engine is configured to render a three-dimensional representation of a simulated fill port strain contour at one or both of during the simulated refrigerant charging process and after the simulated refrigerant charging process.

In another aspect, a computer-implemented method for virtual testing of a vehicle air conditioning (A/C) system configuration is described.

In the following description, there are shown and described embodiments of systems and methods for virtual analysis of structural integrity of a vehicle A/C system. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed systems and methods for virtual analysis of structural integrity of a vehicle A/C system, and together with the description serve to explain certain principles thereof. In the drawings:

FIG. 1 depicts a representative vehicle A/C line geometry;

FIG. 2 depicts a representative refrigerant charging process for the A/C geometry of FIG. 1;

FIG. 3 depicts in flow chart form a method for virtual analysis of structural integrity of a vehicle A/C system according to the present disclosure;

FIG. 4 depicts a representative virtual A/C system geometry;

FIG. 5 shows a representative A/C geometry deflection plot;

FIG. 6 graphically illustrates a representative system for implementing the method illustrated in FIG. 3;

FIG. 7 shows in flow chart form a representative fill port workflow analysis;

FIG. 8 depicts a representative A/C line construction;

FIG. 9A depicts a representative three-dimensional A/C geometry rendered using the system of FIG. 6 and the method of FIG. 3, and showing deflection responses of an A/C line on application of a load force; and

FIG. 9B plots representative deflections of the A/C geometry of FIG. 9A.

Reference will now be made in detail to embodiments of the disclosed systems and methods for virtual analysis of structural integrity of a vehicle A/C system, examples of which are illustrated in the accompanying drawing figures wherein like reference numerals identify like features.

### DETAILED DESCRIPTION

At a high level, the present disclosure is directed to a computer-aided engineering process and system for evaluating structural performance of the refrigerant lines of an A/C system. The system simulates forces imposed on elements of the A/C system by refrigerant charging equipment conventionally utilized during vehicle assembly. The system and process take into account such forces as well as A/C line geometry and material properties, and determines maximum deflection and maximum stress imposed by the refrigerant charging equipment on elements of the A/C system. By the described process and system, A/C line geometry and materials may be selected, tested, and optimized prior to prototype fabrication and physical testing.

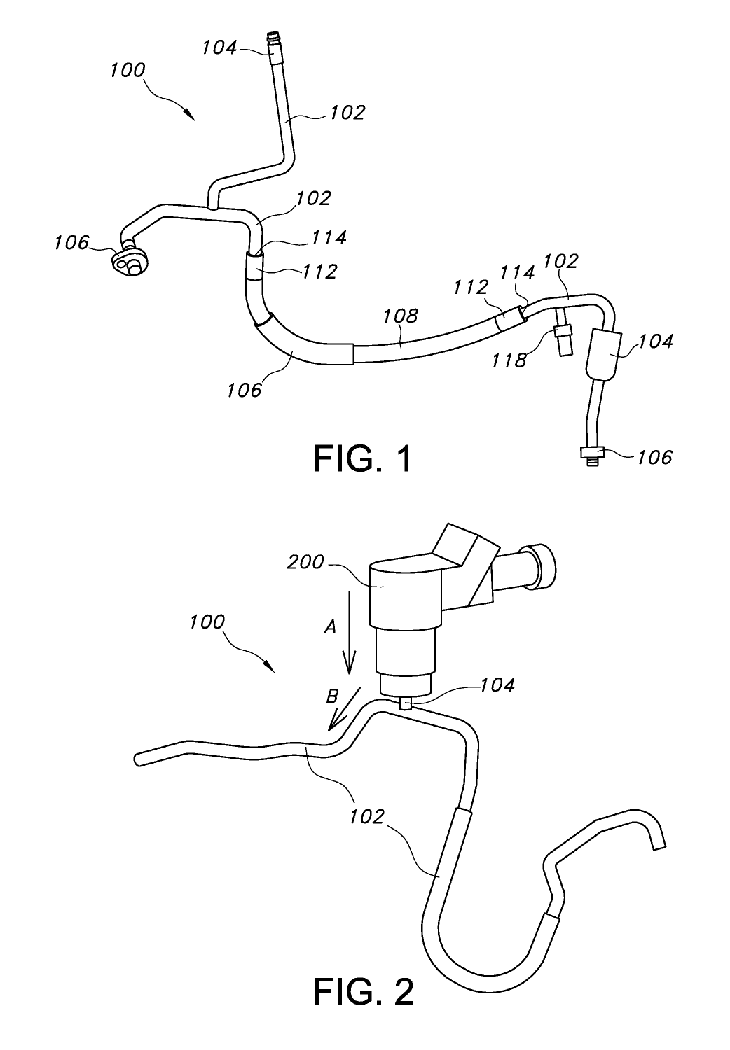

Reference is now made to FIG. 1 schematically illustrating a representative vehicle A/C refrigerant system 100. As is known, the system 100 includes at least a plurality of A/C lines 102 and a fill port 104 by way of which refrigerant is dispensed into the A/C system. Other known elements include one or more of fittings 106, hoses 108, a muffler 110, crimps 112, barbs 114, sleeves 116, and a transducer 118. Of course, the illustrated system 100 is representative only, and may vary according to size, components, etc. from vehicle make/model to vehicle make/model.

As shown in FIG. 2, during the process of charging the system 100 with refrigerant, a charge fill tool 200 is attached to the fill port 104. The fill port 104 is opened to allow dispensing refrigerant into the system 100. This typically first occurs during the vehicle manufacturing process, after final vehicle body assembly and prior to shipping the vehicle out. The charge fill tool 200 imposes certain stresses and displacements on elements of the system 100 during the refrigerant fill process, such as during the connecting process and due to the refrigerant filling equipment weight. In particular, the charge fill tool and associated equipment impose a vertical load along a z-axis of the fill port 104 (see arrow A). Also, when the refrigerant fill process is performed as part of manufacture/final assembly of a vehicle, because the vehicle is typically being displaced along an assembly line such as by a conveyor, lateral or horizontal loads are imposed by the charge fill tool and equipment along an x-axis of the fill port 104.

For this reason, it is necessary to ascertain the structural integrity of a vehicle A/C system 100, to ensure that it will not be damaged or permanently deformed during the refrigerant filling process. As a non-limiting example, certain industry performance standards require that a refrigerant fill port and attached refrigerant tubing shall not be damaged or permanently deformed when subjected to 15 pounds-force (lbf) vertical force and 5 lbf horizontal force. This testing is conventionally done by performing physical stress tests of actual A/C line configurations. However, as discussed above physically stress-testing actual prototype A/C line geometries imposes significant time and labor/equipment costs, particularly when one considers the multiple automotive styles/models which are manufactured and assembled in a particular manufacturing facility, each potentially requiring a distinct A/C line configuration/geometry.

To address this problem, the present disclosure describes a computer-implemented system for performing standardized virtual analyses of A/C line strength and stiffness performance when subjected to the loads typically encountered during a refrigerant fill process. As will be appreciated, the described system allows providing a virtual representation of an A/C system in any desired geometry/configuration and using any desired materials, and determining an A/C line assembly response to the vertical and horizontal loads likely to be encountered during a typical refrigerant fill process. This allows obtaining a measure of A/C line design robustness during a refrigerant fill process, without having to perform physical stress tests on a prototype A/C system.

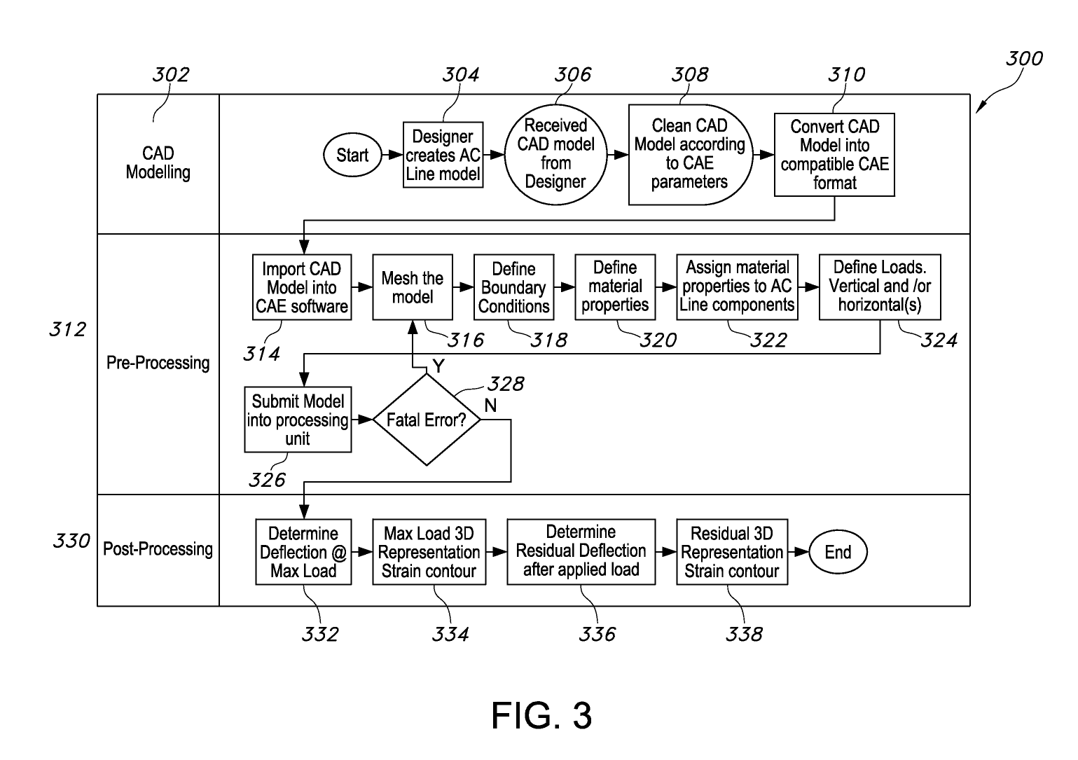

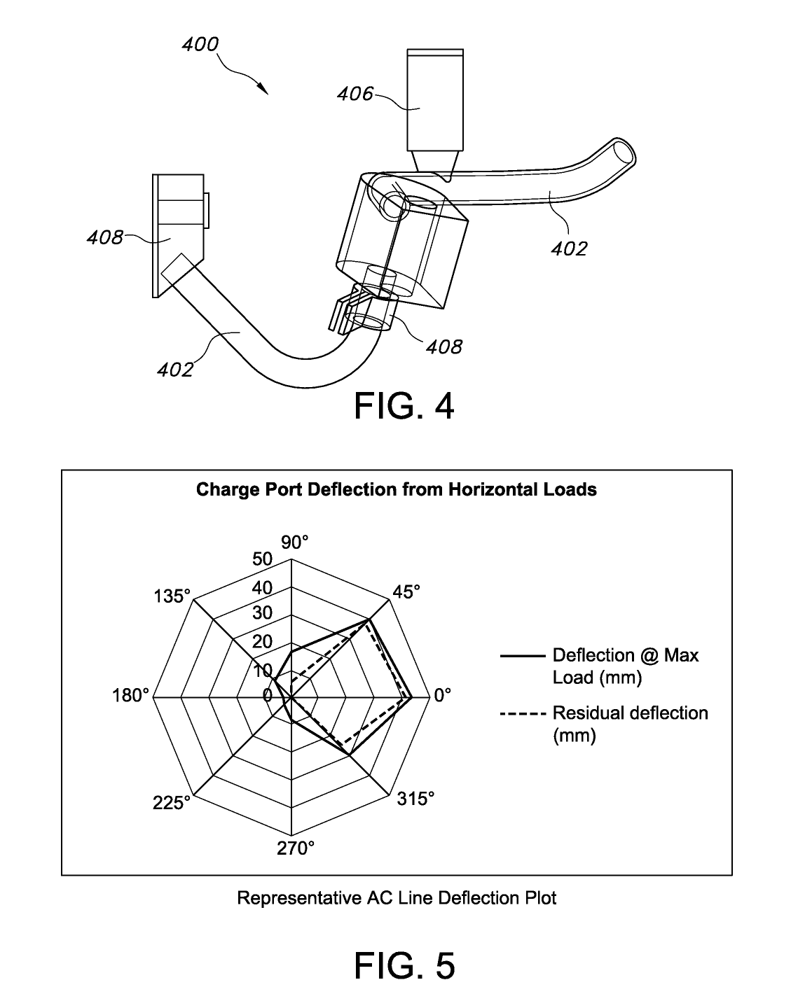

With reference to FIG. 3, the described computer-implemented system performs a method 300 for analyzing a virtual A/C system line strength/stiffness. As will be appreciated, the depicted method steps may be performed sequentially, simultaneously, or a combination. The method includes a step 302 of modelling to configure a virtual A/C geometry 400 (see FIG. 4), including incorporating data relating to the materials of which the A/C system is constructed. The configured virtual A/C geometry includes at least an A/C line 402 and a refrigerant fill port 406. The geometry 400 may further include one or more representations of fixed attachments 408, i.e. boundary conditions representing portions of the A/C line assembly geometry that would be fixed to, e.g., a portion of a vehicle or vehicle component (not shown).

In greater detail, modelling step 302 includes a step 304 of creation of a virtual A/C line model geometry 400, such as by a Computer-Aided Design (CAD) program. At step 306, the CAD model is received, and at step 308 is refined as needed according to Computer-Aided Engineering (CAE) principles. Next, at step 310 the CAD model is converted into a suitable CAE-compatible format.

Next is a pre-processing step 302. After importation of the CAD model into CAE software (step 314), the model is meshed (step 316) and boundary conditions defined (step 316). At step 320, material properties are defined. As will be appreciated, this entails selection of particular materials of which the A/C line geometry is to be constructed. At step 322, the selected material physical properties are input into the CAE program. Next, at step 324 particular vertical and/or horizontal loads to which the modelled A/C line 400 geometry will be subjected during analysis are defined. As discussed above, these defined loads may be established by industry standard or governmental regulation, or may be established by a particular manufacturer. As set for the above, in one embodiment a representative defined load is a 15 lbf vertical force and a 5 lbf horizontal force. Next, at step 326 the modelled A/C line 400 geometry including the selected material physical property and load definitions are submitted to a processing unit for validation. If a fatal error is detected, the process is repeated to correct the error (step 328). If not, the virtual system is ready for analysis.

Step 330 is a post-processing step wherein the modelled A/C line 400 geometry is subjected to the defined simulated vertical and/or horizontal loads. The modelled system is analyzed to determine a deflection at a maximum or fully applied simulated vertical and/or horizontal load (step 332) and a virtual three-dimensional representation of the determined maximum load is rendered (step 334). With reference to FIG. 4, in embodiments multiple virtual horizontal loads may be applied and released at increments along a 360 degree circumference surrounding the fill port 406 z-axis as would be expected for an A/C line geometry associated with a vehicle travelling along an assembly line. In the depicted embodiment, a vertical load is applied, and 8 horizontal loads are applied and released at 45 degree increments along the 360 degree circumference. Of course, these are representative only, and alternative vertical and horizontal loads are possible and contemplated for use herein. Next (step 336), the system determines a residual deflection after application and release of the defined simulated vertical and/or horizontal loads, and a virtual three-dimensional representation of the determined residual strain contour is rendered (step 338).

These deflection responses may be plotted to provide a measure of the amount of deflection of the A/C fill port 406 encountered during a simulated refrigeration fill process, and equally importantly a measure of the amount of residual deflection after the fill process is terminated (see FIG. 5). Finally, the system 300 optionally provides three-dimensional representations of the A/C system 400 during (step 334) and after (step 338) the simulated application of loads (steps 332 and 336), to visually illustrate plastic strain contours imposed on the A/C system deflected geometry during the fill process and also the residual plastic strain contours after the fill process is terminated.

A representative plot of maximum and residual deflection of a virtual fill port 406 is shown in FIG. 5. As depicted in FIG. 4, a horizontal load was applied to the fill port 406 at 0 degrees laterally to the fill port 406 x-axis. While lateral deflection (solid line) of the fill port 406 is shown, the residual deflection (broken line) is acceptable. Thus, a measure of the A/C system line strength and stiffness is provided. In a typical analysis, this analysis and plotting would be repeated at 45 degree increments (or any other desired or required spacing) along the 360 degree circumference surrounding the fill port 406 z-axis.

The method set forth in FIG. 3 is typically performed by way of computerized systems including programmable processor-based systems comprising one or more computing devices. The specific nature of such systems is known in the art and does not require extensive discussion herein. However, at a high level computing devices may be arranged as individual or networked physical or virtual machines, including a host machine client machines arranged with a variety of other networks and computing devices. The host machine may typify a server of varying design. The client machines may be general or special purpose computing devices, including conventional fixed and mobile devices having an attendant monitor and user interface such as a keyboard and/or a mouse. The computer internally includes a processing unit of varying design and manufacture, at least one memory, and a bus that couples various internal/external units such as PDAs, cameras, scanners, printers, hand-held devices, storage devices, and others. Storage devices may be local or remote. The host and client machines may communicate with one another by wired connections, wireles sly, or via combinations that are direct (intranet) or indirect. Multiple network types are known including without intending any limitation local area networks (LAN), metro area networks (MAN), wide area networks (WAN), and storage area networks (SAN).

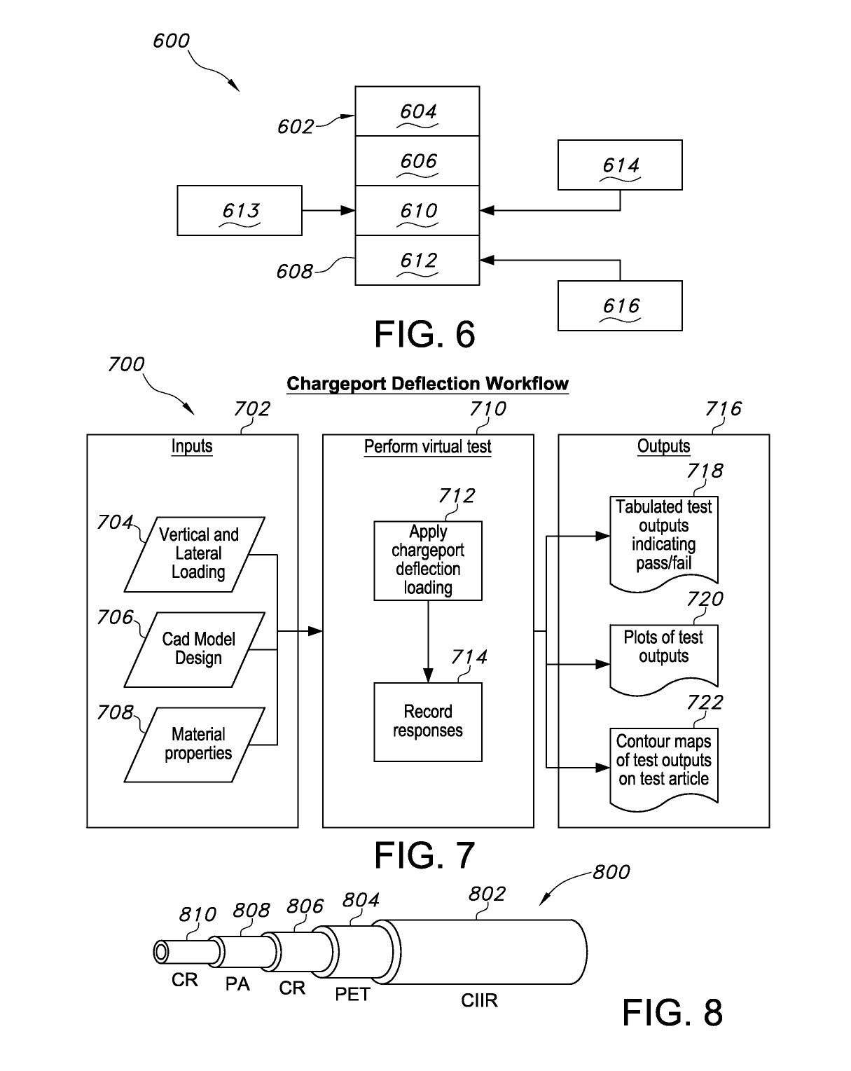

In an embodiment, with reference to FIG. 6 a programmable processor-based system 600 for performing the computer-implemented method set forth in FIG. 3 includes a one or more computing devices 602 including at least one processor 604 operable to execute computer-readable instructions, at least one graphics processing unit 606, and at least one memory 608 which may be any suitable memory, e.g. RAM, ROM, EEPROM, and others. The processor 604 is configured to execute computer-readable instructions including at least a rendering engine 610 configured to render a three-dimensional A/C system representation simulating an A/C system 400 geometry including at least an A/C fill port 406 and at least one A/C tube 402 as described above. Particular A/C geometries may be selected from an A/C geometry library 613 including information regarding various A/C system components. The rendering engine 610 may comprise a CAD program of substantially known design and/or a CAE program of substantially known design as described above, and others. The processor further is configured to render a three-dimensional representation of the A/C system 400 including information relating to at least structural strength and stiffness of the system according to the material properties of the materials of which the A/C lines 402 and fill port 406 are fabricated. Such material properties may be obtained from a stored materials library 614, or may be individually input by a user.

The computer-readable instructions further include a finite element analysis engine 612 configured as described above to simulate an A/C refrigerant charging process including application of vertical and horizontal loads as described above. Such loads may be obtained from a stored load library 616, or may be individually input by a user. The finite element analysis engine 612 in an embodiment is a CAE program as is known in the art, configured for stress analysis of various simulated solids and structures in statics and dynamics. Such analysis engines are well-known to the skilled artisan. The rendering engine 610, finite element analysis engine 612, and libraries 613, 614, 616 may be stored locally in memory 608, on a suitable storage medium such as various known computer-readable media (magnetic disks, optical disks, flash drives, CD-ROM, DVD, etc.) or may be stored remotely for download, such as in a cloud-based system as is known in the art, for subsequent access by the system 600.

A high level depiction of a representative fill port 104 deflection workflow 700 and analysis performed by the processor-based system 600 is presented in FIG. 7. As shown therein, various inputs 702 are presented to the system as depicted in FIG. 6. In the depicted embodiment, the inputs include a load input 704, i.e. the particular vertical and lateral loads to be imposed on a simulated A/C line geometry. In turn, a desired simulated A/C line geometry input 706 is provided by the rendering engine 610. A representative example rendering engine 610 is a CAD model design of an A/C line assembly geometry. Further, a material property input 708 is provided, including known properties of particular materials of which the A/C line assembly geometry will be constructed.

Continuing, at step 710 the horizontal and vertical load analysis is performed by the finite element analysis engine 612. This includes a step 712 of applying the simulated fill port deflection loads, and a step 714 of recording the deflection responses provided by the simulated A/C line assembly geometry.

The system 600 generates a number of outputs 716, including test outputs 718 indicating whether the simulated A/C line assembly geometry passed or failed. The system also provides test output plots 720, showing the determined vertical and horizontal deflection responses of the simulated A/C line assembly geometry. Likewise, contour maps 722 illustrating the determined vertical and horizontal deflection responses of the simulated A/C line assembly geometry.

FIG. 8 illustrates a representative A/C hose line 800 configuration and material composition. As shown, the representative line 800 includes several layers 802, 804, 806, 808, and 810 of concentrically nested materials. In the depicted embodiment, the outermost layer 802 comprises chlorobutyl (CIIR), the next layer 804 comprises polyethylene (PET), the next layer 806 comprises neoprene (CR), the next layer 808 comprises polyamide (PA), and the innermost layer 810 comprises CR. As will be appreciated, the material properties of these and other materials of which A/C hose lines 800 may be manufactured are known in the art.

Likewise, material properties of other components of an A/C line assembly can be ascertained. For example, it is known to manufacture various elements of an A/C line assembly as described above, such as an A/C tube, a charge valve, a muffler, and various fittings of aluminum, such as Al 3003. Other elements such as brackets may be manufactured of known alloys such as low carbon steel. Again, the material properties of these and other materials of which A/C line assembly components may be manufactured are known in the art.

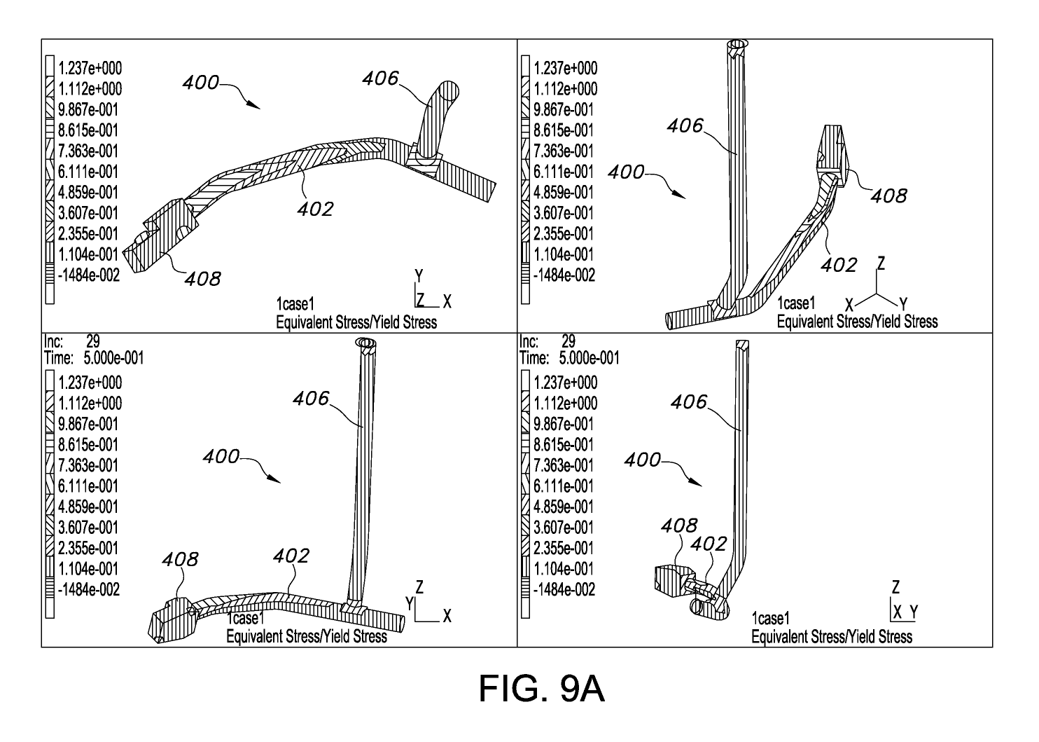

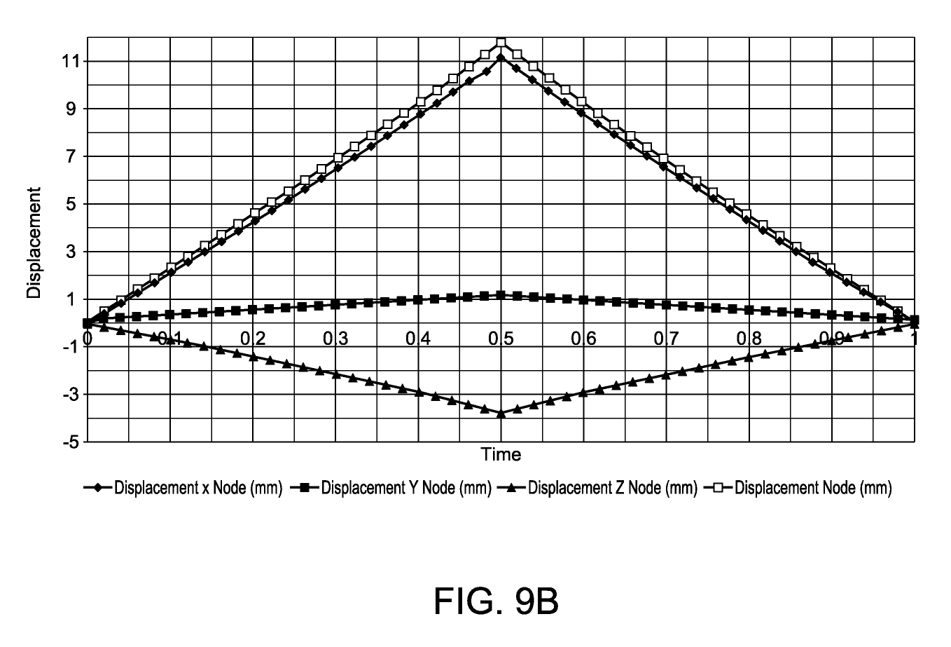

FIGS. 9A and 9B depict certain outputs provided by the system 600 during a representative virtual charge port 406 deflection analysis performed by the system of FIG. 6 implementing the method of FIG. 3 on the simulated A/C system geometry 400 of FIG. 4. FIG. 9A provides various views of a three-dimensional representation of the geometry 400, and shows the stress contour response of a simulated A/C line 402 on application of a simulated horizontal and vertical load as described above. FIG. 9B plots the maximum and residual deflections caused by the simulated application of horizontal and vertical loads. As described above (see also FIG. 5), the simulated A/C system 400 was subjected to a simulated vertical load of 15 lbf and a horizontal load of 5 lbf at 0 degrees laterally to the fill port 406 x-axis. The results are also shown in Table 1 below.

TABLE 1
Virtual Charge Port Deflection analysis at a single loading direction.
SAMPLE DEFLECTION ANALYSIS MEASURED AT THE FILL PORT

| | X | Y | Z | Magnitude |
|---|---|---|---|---|
| | (mm) | (mm) | (mm) | (mm) |
| Deflection at maximum load | 28 | −2.98 | −27.38 | 39.28 |
| Residual deflection | 1.66 | 0.38 | −0.74 | 1.86 |

Thus, the depicted virtual A/C system 400 exhibited acceptable deflection and residual deflection when subjected to stresses typical of a refrigerant charging process at an automotive assembly facility.

Obvious modifications and variations are possible in light of the above teachings. All such modifications and variations are within the scope of the appended claims when interpreted in accordance with the breadth to which they are fairly, legally and equitably entitled.

What is claimed:

1. A computer-implemented system for virtual testing of a vehicle air conditioning (A/C) system configuration, comprising:
a programmable processor-based subsystem including at least one processor operable to execute computer-readable instructions, at least one graphics processing unit, and at least one memory, said instructions including at least:
a) a rendering engine configured to render a three-dimensional A/C system representation simulating an A/C line assembly geometry including at least a fill port, at least one A/C line, and at least one A/C line assembly boundary condition; and
b) a finite element analysis engine configured to simulate an A/C refrigerant charging process.

2. The system of claim 1, wherein the finite element analysis engine is configured to simulate an application of, by a simulated refrigerant fill tool, one or both of a vertical load on a z-axis of the simulated A/C line assembly and at least one horizontal load applied on an x-axis of the simulated fill port.

3. The system of claim 2, wherein the finite element analysis engine is configured to calculate one or both of a simulated fill port deflection at a fully applied vertical load and/or horizontal load and a residual simulated A/C line assembly deflection after the application of the fully applied vertical load and/or the horizontal load.

4. The system of claim 3, wherein the rendering engine is configured to render a three-dimensional representation of a simulated A/C line strain contour at one or both of during and after the fully applied vertical load and/or horizontal load.

5. The system of claim 2, wherein the finite element analysis engine is configured to simulate an application of the horizontal load at increments over a 360 degree circumference surrounding the z-axis of the simulated fill port.

6. The system of claim 1, wherein said instructions further include defining material properties of one or more materials comprising the simulated A/C line assembly.

7. The system of claim 2, wherein the finite element analysis engine is configured to simulate at least an application and a release of a vertical load of about 15 pounds-force.

8. The system of claim 2, wherein the finite element analysis engine is configured to simulate at least an application and a release of a horizontal load of about 5 pounds-force.

9. A computer-implemented method for virtual testing of a vehicle air conditioning (A/C) system configuration, comprising:
subjecting a three-dimensional representation of the A/C system to a simulated refrigerant charging process using a programmable processor-based subsystem including at least one central processing unit operable to execute computer-readable instructions, at least one graphics processing unit, and at least one memory, said instructions including at least:
a) a rendering engine configured to render a three-dimensional A/C system representation simulating an A/C line assembly geometry including at least a fill port, at least one A/C line, and at least one A/C line assembly boundary condition; and
b) a finite element analysis engine configured to simulate an A/C refrigerant charging process.

10. The method of claim 9, including configuring the finite element analysis engine to simulate an application of, by a simulated refrigerant fill tool, one or both of a vertical load on a z-axis of the simulated A/C line assembly and at least one horizontal load applied on an x-axis of the simulated fill port.

11. The method of claim 10, including configuring the finite element analysis engine to calculate one or both of a simulated fill port deflection at a fully applied vertical load and/or horizontal load and a residual simulated A/C line assembly deflection after the application of the fully applied vertical load and/or the horizontal load.

12. The method of claim 11, including configuring the rendering engine to render a three-dimensional representation of a simulated A/C line strain contour at one or both of during and after the fully applied vertical load and/or horizontal load.

13. The method of claim 10, including configuring the finite element analysis engine to simulate an application of the horizontal load at increments over a 360 degree circumference surrounding the z-axis of the simulated fill port.

14. The method of claim 13, including defining material properties for one or more materials comprising the simulated A/C line assembly.

15. The method of claim 10, including configuring the finite element analysis engine to simulate at least an application and a release of a vertical load of about 15 pounds-force.

16. The method of claim 10, including configuring the finite element analysis engine to simulate at least an application and a release of a horizontal load of about 5 pounds-force.

17. A computer-implemented system for virtual testing of a vehicle air conditioning (A/C) system configuration, comprising:
a programmable processor-based subsystem including at least one central processing unit operable to execute computer-readable instructions, at least one graphics processing unit, and at least one memory, said instructions including at least:
a) a rendering engine configured to render a three-dimensional A/C system representation simulating an A/C line assembly geometry including at least a fill port, at least one A/C line, and at least one A/C line assembly boundary condition; and
b) a finite element analysis engine configured to simulate an A/C refrigerant charging process;
wherein the finite element analysis engine is configured to simulate an application of, by a simulated refrigerant fill tool, one or both of a vertical load on a z-axis of the simulated A/C line assembly and at least one horizontal load applied in increments over a 360 degree circumference surrounding the z-axis of the simulated fill port.

18. The system of claim 17, wherein the finite element analysis engine is configured to calculate one or both of a simulated fill port deflection at a fully applied vertical load and/or horizontal load and a residual simulated A/C line assembly deflection after the application of the fully applied vertical load and/or the horizontal load; and
further wherein the rendering engine is configured to render a three-dimensional representation of a simulated A/C line strain contour at one or both of during and after the fully applied vertical load and/or horizontal load.

19. The system of claim 17, wherein the finite element analysis engine is configured to simulate an application of the horizontal load in 45 degree increments over a 360 degree circumference surrounding the z-axis of the simulated fill port.

20. The system of claim 19, wherein the finite element analysis engine is configured to simulate at least an application and a release of a vertical load of about 15 pounds-force and an application and a release of a horizontal load of about 5 pounds-force.
